(19) United States
(12) Patent Application Publication
(10) Pub. No.: US 2024/0245133 A1
(43) Pub. Date: Jul. 25, 2024

(54) Aerosol Generating Device Comprising a Temperature Sensor

(71) Applicant: JT International S.A., Geneva (CH)

(72) Inventors: Simon Dodd, Albany, OR (US); Dan Negrescu, Barcelona (ES); James Alan Mott, San Diego, CA (US); Bruce Michael Eckard, San Diego, CA (US)

(73) Assignee: JT International S.A., Geneva (CH)

(21) Appl. No.: 18/560,842

(22) PCT Filed: May 12, 2022
(86) PCT No.: PCT/EP2022/062934

§ 371 Date: Nov. 14, 2023

(30) Foreign Application Priority Data
May 14, 2021 (EP) 21173905.7

(51) Int. Cl. A24F 40/51; A24F 40/05; A24F 40/46; A24F 40/48; A24F 40/57; A24F 40/65; G01K 3/00; G01K 13/024

(52) U.S. Cl. CPC A24F 40/51; A24F 40/05; A24F 40/46; A24F 40/48; A24F 40/57; A24F 40/65; G01K 3/005; G01K 13/024

(57) ABSTRACT

An aerosol generating device comprises an atomizer configured to generate aerosol from a vaporizable material; an airflow path configured to conduct an airflow between an air inlet and an air outlet; a heater arranged in the airflow path and being separated from the atomizer; a temperature sensor; and a microcontroller. The airflow path comprises an upstream portion extending between the air inlet and the atomizer, and a downstream portion extending between the atomizer and the air outlet. The temperature sensor is arranged in the downstream portion of the airflow path and is configured to generate temperature measurements relative to the temperature of the airflow passing through the downstream portion, and the microcontroller is configured to operate the heater according to those temperature measurements.

### FIELD OF THE INVENTION

The present invention concerns an aerosol generating device.

The aerosol generating device according to the invention is adapted to generate and dispense aerosol inhalable by a user. The aerosol can be used by the user for therapeutic purposes or non-medical purposes. In this last case, the aerosol generating device can be used as a reduced-risk device for smokers, also known as a vaporiser.

### BACKGROUND OF THE INVENTION

Known aerosol generating devices comprise generally an atomizer able to form aerosol from a vaporizable material. The principal aim of the atomizer is to create drops or droplets of at least some components of the vaporizable material and deliverer these drops or droplets to a user through for example an airflow created by the user inhalations. The vaporizable material can present solid or liquid substrate.

Depending on the nature of the vaporizable material, the atomizer may use different techniques to form drops. The most known technique to form drops consists in heating the vaporizable material. The aerosol generated by heating is thus called “hot vapour”. Other known techniques, as for example ultrasonic mesh technique, can form drops without heating. The aerosol generated by this technique may have substantially ambient temperature and is thus called “cold vapour”.

In both cases, the vapour temperature may differ substantially from the human body temperature and create thus an unpleasant effect to the user.

### SUMMARY OF THE INVENTION

One of the aims of the invention is to provide an aerosol generating device allowing to improve the user experience by avoiding unpleasant effects which can be caused by hot or cold vapour.

For this purpose, the invention relates to an aerosol generating device comprising:
an atomizer configured to generate aerosol from a vaporizable material;
an airflow path configured to conduct an airflow between an air inlet and an air outlet, the airflow path in fluid communication with the atomizer and comprising an upstream portion extending between the air inlet and the atomizer, and a downstream portion extending between the atomizer and the air outlet;
a heater arranged in the airflow path and being separated from the atomizer;
a temperature sensor arranged in the downstream portion of the airflow path and configured to generate temperature measurements relative to the temperature of the airflow passing through this portion;
a microcontroller configured to operate the heater, according to said temperature measurements.

Using the temperature sensor arranged in the downstream portion in relation with the atomizer, it is possible to determine precisely the temperature of the aerosol which is delivered to the user. Using this temperature, the microcontroller can control the operation of the heater which is separated from the atomizer and is able to affect the temperature of the aerosol. Thus, the microcontroller, the heater and the temperature sensor can form a closed loop controlling for example permanently or periodically the temperature of the delivered aerosol. This temperature can be adapted to the human body temperature so that no unpleasant effect is created to the user while using the aerosol generating device.

Additionally, since the heater is separated from the atomizer, it can be arranged either in the upstream portion of the airflow path or in the downstream portion of the airflow path. It is thus clear that in the first case, the heater is adapted to heat the airflow used by the atomizer to form aerosol and in the second case, the heater is adapted to heat the aerosol formed by the atomizer. It is also clear that the heater is not adapted to heat directly the vaporizable material.

According to some embodiments, the microcontroller is configured to operate the heater to achieve a target temperature of the airflow passing through the downstream portion of the airflow path.

Thanks to these features, it is possible to ensure substantially the same temperature of the aerosol while using the aerosol generating device.

According to some embodiments, the microcontroller is configured to compare the temperature measurements with the target temperature, and operate the heater further to this comparison.

Thanks to these features, the microcontroller can control the operation of the heater basing on said comparison. For example, if the temperature according to the temperature measurements is less than the target temperature, the microcontroller can activate the operation of the heater or increase the power supplying of the heater. If the temperature according to the temperature measurements is greater than the target temperature, the microcontroller can deactivate the operation of the heater or decrease its power supply.

According to some embodiments, the aerosol generating device further comprises a mouthpiece, the air outlet being arranged in the mouthpiece.

According to some embodiments, the temperature sensor is adjacent to the mouthpiece.

Thanks to these features, the temperature sensor is in the closest position with the user's mouth and lips. Thus, the temperature measurements provided by the sensor are representative with a high precision of the real temperature of the aerosol inhaled by the user.

According to some embodiments, the heater is arranged in the upstream portion of the airflow path.

Thanks to these features, the heater may heat the airflow used by the atomizer to form aerosol. Thus, the aerosol temperature may be more homogeneous.

According to some embodiments, the heater is connected to a battery of the device through the microcontroller.

Thanks to these features, the microcontroller can control in a simple way the operation of the heater by controlling its power supply.

According to some embodiments, the airflow path further comprises a heating part formed by an insulated block, the heater being arranged inside the insulated block.

According to some embodiments, the insulated block is made from ceramic.

Thanks to these features, the heater can control efficiently the temperature of the aerosol.

According to some embodiments, the heater comprises a coil, the airflow path passing through the coil.

Thanks to these features, the heater can have a simple structure and can be arranged easily inside the aerosol generating device, without modifying other internal components of the device.

According to some embodiments, the atomizer is configured to form aerosol using an ultrasonic mesh or an inkjet technology.

Thanks to these features, it is possible to configure precisely the dimensions of the drops/droplets formed the atomizer.

According to some embodiments, the aerosol generating device comprises at least two heaters;

at least a part of the airflow path comprising two branches, each heater being arranged in a respective branch of the airflow path and being operable by the microcontroller.

Thanks to these features, the temperature of the aerosol may be controlled more efficiently.

According to some embodiments, the target temperature is set by a user.

Thanks to these features, the user can set the target temperature using his/her own preferences.

According to some embodiments, the target temperature is set by the user using an external device connected to the aerosol generating device.

Thanks to these features, the target temperature can be set using the external device able to exchange data with the microcontroller. The data can be exchanged using any wire or wireless data transmission protocol, as Bluetooth, NFC, etc.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a schematic view of an aerosol generating device according to a first embodiment of the invention, the aerosol generating device comprising notably a heater assembly;

FIG. 2 is a perspective semi-transparent view of the heater assembly of FIG. 1;

FIG. 3 is a diagram illustrating the operation of the heater assembly of FIG. 1; and

FIG. 4 is a schematic view of an aerosol generating device according to a second embodiment of the invention.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generating device”, “aerosol generation device” or “device” may include a vaping device to deliver aerosol to a user, including aerosol for vaping, by means of aerosol generating unit, also called atomizer (e.g. an aerosol generating element which generates vapour which condenses into aerosol before delivery to an outlet of the device at, for example, a mouthpiece, for inhalation by a user). The device may be used for therapeutic purposes or non-medical purposes. In the first case, the aerosol formed by the device may be used to treat a disease, notably a respiratory disease. In the second case, the device may be used as a reduced-risk device intended to assist habitual smokers wishing to quit smoking traditional tobacco products such as cigarettes, cigars, cigarillos, and rolling tobacco. In both cases, the device may be portable. “Portable” may refer to the device being for use when held by a user.

The device may be adapted to generate a variable amount of aerosol, e.g. by activating the atomizer for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.).

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” or “aerosol forming substance” or “substance” is used to designate any material that is vaporizable in air to form aerosol. Vaporization is generally obtained by a temperature increase up to the boiling point of the vaporization material, such as at a temperature less than 400° C., preferably up to 350° C. The vaporizable material may, for example, comprise or consist of an aerosol-generating liquid, gel, wax, foam or the like, an aerosol-generating solid that may be in the form of a rod, which contains processed tobacco material, a crimped sheet or oriented strips of reconstituted tobacco (RTB), or any combination of these. The vaporizable material may comprise one or more of: nicotine, caffeine or other active components. The active component may be carried with a carrier, which may be a liquid. The carrier may include propylene glycol or glycerin. A flavouring may also be present. The flavouring may include Ethylvanillin (vanilla), menthol, Isoamyl acetate (banana oil) or similar. In some cases, the vaporizable material can include a medical substance.

As used herein, the term “puff” or “user puffer” may refer to a user action performed to inhale the aerosol generated by the aerosol generating device. This action can be performed by the user through a mouthpiece opening to an airflow path of the aerosol generating device. Thus, a puff creates an airflow in the airflow path.

As used herein, the term “external device” may refer to a device, which is able to establish a wire or wireless data connection with the aerosol generating device. Such an external device may be a mobile device like a mobile phone for example. Additionally, such an external device may be a smart device able to process at least some data received from the aerosol generating device or intended to be transmitted to the aerosol generating device. Such a smart device can be a smartphone, a smartwatch, a tablet computer, a laptop, a desktop computer or any other smart object implemented for example according to the IoT (“Internet of things”) technology. Such a smart device can be also another aerosol generating device similar to said aerosol generating device. In some embodiments, the external device may be a distant server able to process data.

### First Embodiment of the Invention

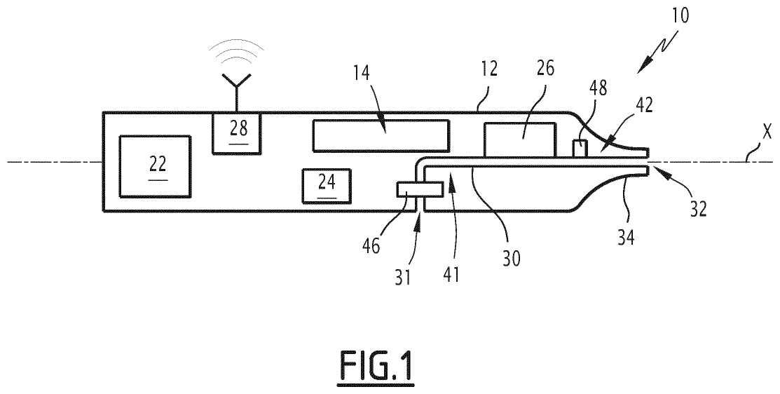

Referring to FIG. 1, an aerosol generating device 10 according to the first embodiment of the invention is shown. In the example of this Figure, the aerosol generating device 10 is a reduced-risk device for smokers, also known as a vaporiser or e-cigarette. According to other examples of the invention, the aerosol generating device 10 may present any other type of device as explained above, notably a device used for therapeutic purposes.

The aerosol generating device 10 comprises a device body 12 extending, in the example of FIG. 1, according to a device axis X. The device body 12 defines a reception cavity 14 configured to receive a consumable article containing a vaporizable material. Depending on the consumable article's shape, the reception cavity 14 can for example form a circular or rectangular cross-section. In the example of FIG. 1, the consumable article may be a cartridge containing a vaporizable material in liquid form. According to another example, the consumable article may contain a vaporizable material in solid form like for example a tobacco rod or stick. According to still another example, the reception cavity 14 may present a fixed storage portion able to store a vaporizable material for example in liquid form and configured for example to be refilled by a user. Another example may correspond to any combination of the abovementioned examples.

The device body 12 delimits an interior part of the aerosol generating device 10 and comprises a power block 22 designed to power the device 10, a microcontroller 24 powered by the power block 22 and an atomizer 26 designed to form aerosol and controlled by the microcontroller 24. The device body 12 of the aerosol generating device 10 may further comprise other internal components performing different functionalities of the device 10 known per se as for example a communication block 28 also shown on FIG. 1.

The device body 12 further comprises an airflow path 30 extending inside the device body 12 between an air inlet 31 and an air outlet 32, and being in fluid communication with the atomizer 26. For example, the atomizer 26 can be adjacent to the airflow path 30. The airflow path 30 is configured to conduct an airflow between the air inlet 31 and the air outlet 32 while user puffs. The air inlet 31 is arranged for example on a lateral wall of the device body 12 whereas the air outlet is arranged on a mouthpiece 34 intended to be in contact with the user's mouth and lips. In the example of FIG. 1, the mouthpiece 34 is formed by the device body 12 on one of its ends. According to other examples, the mouthpiece 34 can be formed by the consumable article or a removable part of the device body 12. The airflow path 30 comprises an upstream portion 41 extending between the air inlet 31 and the atomizer 26, and a downstream portion 42 extending between the atomizer 26 and the air outlet 32.

Additionally, according to the invention, the device body 12 further comprises a heater assembly 46 arranged in fluid communication with the airflow path 30 and a temperature sensor 48 arranged in the downstream portion 42 of the airflow path 30.

It should be noted that FIG. 1 presents only a schematic diagram of different components of the aerosol generating device 10 and does not necessarily show the real physical arrangement and dimensions of these components. Particularly, such an arrangement can be chosen according to the design of the aerosol generating device 10 and technical features of its components.

The power block 22 comprises a battery and a battery charger. The battery is for example a known battery designed to be charged using the power supply furnished by an external source and to provide a direct current of a predetermined voltage. The battery charger is able to connect the battery to the external source and comprises for this purpose a power connector (like for example a mini-USB or USB-C connector) or wireless charging connector. The battery charger is also able to control the power delivered from the external source to the battery according for example to a predetermined charging profile. Such a charging profile can for example define a charging voltage of the battery depending on its level of charge.

The communication block 28 comprises for example a communication module and an antenna able to establish a wireless connection with an external device. The connexion is for example established according to a known wireless protocol such as Bluetooth, WiFi, NFC, etc. The communication module is able to receive data generated by the external device and transmit this data to the microcontroller 24. In some embodiments, the communication module is also able to form data from radio waves received by the antenna, to transmit this data to the microcontroller 24. In some embodiments, instead of the antenna, the communication block 28 comprises a connector able to establish a wire connection with the external device. In this case, the connector can be the same as the power connector mentioned above. In some embodiments, the communication block 28 may be embedded in the microcontroller 24.

The atomizer 26 is configured to generate aerosol from the vaporizable material in the downstream portion 42 of the airflow path 30. For this purpose, the atomizer 26 may be connected to the reception cavity 14 or be in contact with this this cavity 14 or be in fluid communication with this cavity 14. The atomizer 26 can be implemented according to any one of known techniques making it possible to form aerosol from a vaporizable material in solid and/or liquid form. According to the preferred embodiment of the invention and when the vaporizable material is in liquid form, the atomizer 26 is implemented according to an inkjet technology, preferably a thermal inkjet technology. In this case, the atomizer 26 may comprise one or several fluid intake needles configured to plunge in the reception cavity 14 and a surface communicating with the needles and adapted to form droplets via nozzles, using for example a heating element. This surface can be arranged in the airflow path 30 so as the droplets are carried by the airflow formed in the airflow path 30 and caused by user puffs. In some embodiments, instead of a thermal inkjet technology, piezoelectric inkjet technology can be used. According to still another embodiment, the atomizer 26 comprises an ultrasonic mesh configured to form aerosol from a vaporizable material in liquid form. Thus, in this case, the aerosol is formed by mesh vibrations, without heating the vaporizable material. According to other embodiments of the invention, the atomizer 26 can be implemented according to any other technique to form aerosol, notably a technique comprising heating the vaporizable material. In this last case, the atomizer 26 may comprise a heating element arranged for example around a wick in fluid communication with the vaporizable material. In some embodiments, the atomizer 26 may further comprise an internal temperature sensor connected to the microcontroller 24 which may for example control the operation of the atomizer 26 according to temperature measurements provided by this internal temperature sensor.

The heater assembly 46 is configured to heat the aerosol delivered through the airflow path 30 to the user. In the example of FIG. 1, the heater assembly 46 is arranged in the upstream portion 41 of the airflow path 30. This means that according to this example, the airflow entering inside the device body 12 through the air inlet 31 is heated before passing near or over the atomizer 26, i.e. before being mixed with the droplets formed by the atomizer 26. According to another example of the invention, it is possible to arrange the heater assembly 46 in the downstream portion 42 of the airflow path 30. In this case, the heater assembly 46 is configured to heat the aerosol upon its generation by the atomizer 26.

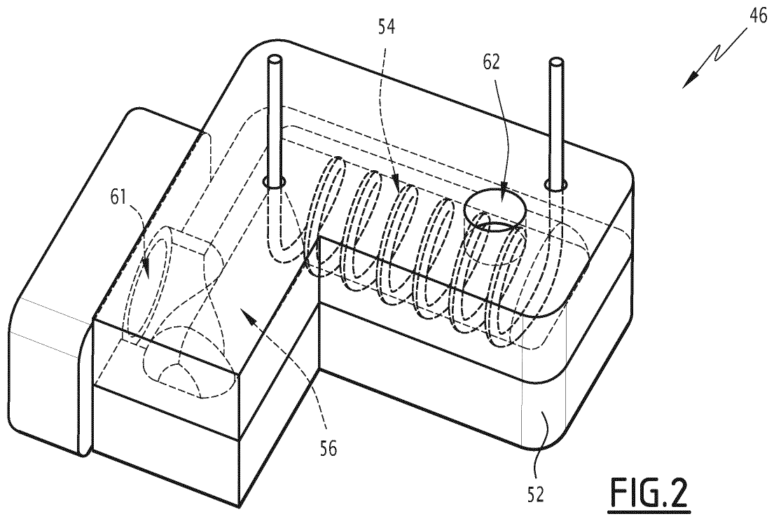

An example of the heater assembly 46 is shown in more detail in FIG. 2. In reference to this FIG. 2, the heater assembly 46 comprises an insulated block 52 and a heater 54 arranged inside the insulated block 52. The insulated block 52 is formed by a box crossed by an inside channel 56 forming a part of the airflow path 30. Particularly, in the example of the Figures, this inside channel 56 forms a part of the upstream portion 41 of the airflow path 30. This part is called hereinafter heating part since it heats the airflow passing therein. The inside channel 56 extends from an inlet hole 61 until an outlet hole 62 formed in walls of the box. The inlet hole 61 may be adjacent to the air inlet 31 and the outlet hole 62 is in fluid communication with the atomizer 26. Additionally, as shown on FIG. 2, the inside channel 56 may deviate the airflow to guide it according to a predetermined direction until the atomizer 26. Particularly, in the example of FIG. 2, the inside channel 56 has an “L” shape. The box forming the insulated block 52 is formed from an insulating material, preferably a heat resistant material like ceramic. The heater 54 is advantageously arranged around at least a part of the inside channel 56 to heat the airflow passing through this channel 56. The heater 54 may be formed by a coil defining two contact ends. The contact ends may cross a wall of the insulated block 52 to be connected to the microcontroller 24. In some embodiments, the heater 54 may be arranged in the airflow path 30 without the insulated block 52.

Referring again to FIG. 1, the temperature sensor 48 is arranged close to the mouthpiece 34 and advantageously, under the mouthpiece 34. The temperature sensor 48 is configured to generate temperature measurements representative of the temperature of the aerosol passing through the downstream portion 42 of the airflow path 30. The temperature sensor 48 is further configured to transmit these measurements to the microcontroller 24. The temperature sensor 48 can be implemented according to any known technology. In some embodiments, it may be combined with a pressure sensor. In some embodiments, the temperature sensor 48 can further be configured to generate temperature measurements representative of the ambient temperature, for example, when no active inhalation is happing. In other words, the temperature sensor 48 may measure the static air temperature in absence of inhalations.

The microcontroller 24, also called MCU, is adapted to control the operation of the aerosol generating device 10. Particularly, the microcontroller is adapted to control the operation of the atomizer 26 and the heater 54. Advantageously, according to the invention, the microcontroller 24 is adapted to control the operation of the atomizer 26 according to a first control logic and the heater 54 according to a second control logic, the second control logic being independent and different from the first control logic. The microcontroller 24 can be implemented at least partially as a software and/or hardware element. In case of a hardware implementation, at least a part of the microcontroller 24 may be implemented for example as an FPGA (“Field-Programmable Gate Array”) or ASIC (Application-Specific Integrated Circuit).

The first control logic used by the microcontroller 24 to control the atomizer 26 may be chosen according to the nature of the atomizer 26. It may for example comprise an ON-command and OFF-command depending on the user input, temperature of the vaporizable material, stage of the vaping session, etc. Such a control logic is known per se and will not be explained in further detail below.

The second control logic used by the microcontroller 24 to control the heater 54 is chosen according to the temperature measurements provided by the temperature sensor 48 to achieve a target temperature of the aerosol delivered to the user. The target temperature may be predetermined or may by chosen by the user. Particularly, the user may set the target temperature for a single vaping session or for all vaping sessions using a data connection with an external device. As mentioned above, the data connection may be implemented via the communication block 28. In some embodiments, the target temperature may be set from an appropriate interface arranged directly for example on the device body 12.

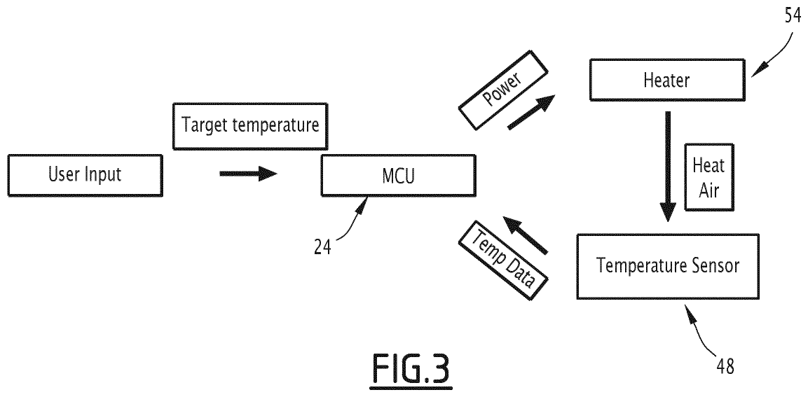

FIG. 3 shows in more detail the second control logic used by the microcontroller 24 to control the operation of the heater 54. Thus, as it is shown on this FIG. 3, this control logic may present a looped control between the microcontroller 24, the heater 54 and the temperature sensor 48. In other words, using such a logic, the microcontroller 24 controls the power supply of the heater 54 according to the temperature measurements transmitted by the temperature sensor 48. Particularly, the microcontroller 24 can compare the temperature measurements transmitted by the temperature sensor 48 with the target temperature and basing on this comparison, control the power supply of the heater 54. For example, when the temperature measurements correspond to a temperature less than the target temperature, an ON-command can be transmitted by the microcontroller 24 to the heater 54. When the temperature measurements correspond to a temperature greater than the target temperature, an OFF-command can be transmitted by the microcontroller 24 to the heater 54. The looped control may be performed continuously during all vaping session or periodically according to predetermined periods. Additionally, the control logic may be based on a more complex algorithm which may for example take into consideration different response times of different components.

### Second Embodiment of the Invention

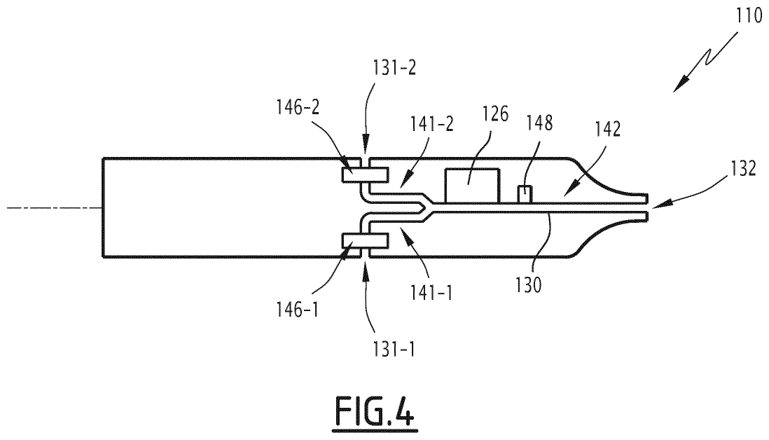

An aerosol generating device 110 according to a second embodiment of the invention is shown on FIG. 4. This aerosol generating device 110 is similar to the device 10 explained above and notably, comprises substantially the same components as those explained before. These common components between both embodiments are not shown on FIG. 4 and will not be explained in detail in relation with the second embodiment of the invention.

As in the previous case, the aerosol generating device 110 according to the second embodiment of the invention comprises an atomizer 126 similar to the atomizer 26 explained above and an airflow path 130 in fluid communication with the atomizer 126. The airflow path 130 also comprises an upstream portion and a downstream portion 142 extending between the atomizer 126 and an air outlet 132. As in the previous case, at least one temperature sensor 148 is arranged in the downstream portion 142 to generate temperature measurements relative to the temperature of the aerosol delivered to the user.

According to the second embodiment of the invention, the upstream portion of the airflow path 130 comprises two branches 141-1, 141-2, each branch extending between a respective air inlet 131-1, 131-2 and the atomizer 126. The air inlets 131-1, 131-2 may for example be arranged on opposite lateral walls of the device body. Additionally, according to the second embodiment, each branch 141-1, 141-2 comprises a heater assembly 146-1, 146-2, each heater assembly being similar to the heater assembly 46 explained above. Notably, each heater assembly 146-1, 146-2 comprises a heater. These heaters are controlled by the microcontroller according to a same control logic or according to different control logics.

In other embodiments, the downstream portion of the airflow path may present several branches, each branch comprises a respective heater assembly. Additionally, in some embodiments, one or several heater assemblies may be arranged in the downstream portion of the airflow path and one or several heater assemblies may be arranged in the upstream portion of the airflow path.

1. An aerosol generating device comprising:
an atomizer configured to generate aerosol from a vaporizable material using an ultrasonic mesh or an inkjet technology;
an airflow path configured to conduct an airflow between an air inlet and an air outlet, the airflow path being in fluid communication with the atomizer, and the airflow path comprising an upstream portion extending between the air inlet and the atomizer, and comprising a downstream portion extending between the atomizer and the air outlet;
a heater arranged in the airflow path and being separated from the atomizer;
a temperature sensor arranged in the downstream portion of the airflow path and configured to generate temperature measurements relative to the temperature of the airflow passing through the downstream portion; and
a microcontroller configured to operate the heater, according to said temperature measurements.

2. The aerosol generating device according to claim 1, wherein the microcontroller is configured to operate the heater to achieve a target temperature of the airflow passing through the downstream portion of the airflow path.

3. The aerosol generating device according to claim 2, wherein the microcontroller is configured to perform a comparison by comparing the temperature measurements with the target temperature, the microcontroller being configured to operate the heater based on the comparison.

4. The aerosol generating device according to claim 1, further comprising a mouthpiece, the air outlet being arranged in the mouthpiece.

5. The aerosol generating device according to claim 4, wherein the temperature sensor is located adjacent to the mouthpiece.

6. The aerosol generating device according to claim 1, wherein the heater is arranged in the upstream portion of the airflow path.

7. The aerosol generating device according to claim 1, wherein the heater is connected to a battery of the device through the microcontroller.

8. The aerosol generating device according to claim 1, wherein the airflow path further comprises a heating part formed by an insulated block, the heater being arranged inside the insulated block.

9. The aerosol generating device according to claim 8, wherein the insulated block is made from ceramic.

10. The aerosol generating device according to claim 1, wherein the heater comprises a coil, the airflow path passing through the coil.

11. The aerosol generating device according to claim 1, wherein the heater includes at least two heaters; wherein at least a part of the airflow path includes two branches; and wherein each of the at least two heaters is arranged in a respective one of the two branches of the airflow path and is operable by the microcontroller.

12. The aerosol generating device according to claim 2, wherein the target temperature is set by a user.

13. The aerosol generating device according to claim 12, wherein the target temperature is set by the user using an external device connected to the aerosol generating device.
